(19) United States
(12) Patent Application Publication
(10) Pub. No.: US 2005/0283930 A1
(43) Pub. Date: Dec. 29, 2005

(54) METAL BRUSH AND METHOD THEREFOR

(76) Inventors: Michael John Hooper, Chestermere (CA); Weng Chee Foong, Calgary (CA); Brett Michael Woods, Calgary (CA); Dolores Laureen Houghton, Calgary (CA)

Correspondence Address: BENNETT JONES;C/O MS ROSEANN CALDWELL, 4500 BANKERS HALL EAST, 855 - 2ND STREET, SW, CALGARY, AB, T2P 4K7, CA

(21) Appl. No.: 10/710,214

(22) Filed: Jun. 25, 2004

(51) Int. Cl. B08B 9/055; A46B 3/06

(52) U.S. Cl. 15/104.061; 15/200

(57) ABSTRACT

A metal brush useful in pipeline pigs, for example, in magnetic flux leakage tools or cleaning tools, a method of making the brush and pipeline pig comprising the brush. The brush has a metal bristle holder and a plurality of metal bristles, the ends of which are held in the bristle holder by being welded to each other and to the bristle holder by fusion welding. The bristle holder may be a tube, or a large metal structure with a hole or cavity. In one embodiment, the brush has a flat bottom surface, and is therefore particularly useful in MFL tools. The brush is not made with solder and therefore avoids many of the problems associated with using solder in pipeline applications, for both MFL and other pipeline applications.

### BACKGROUND OF INVENTION

The present invention relates to the field of metal brushes and methods of making metal brushes.

Metal brushes may be used in various pipeline applications.

For example, Magnetic Flux Leakage (MFL) is an in-line inspection method used to evaluate and monitor metal loss in pipelines, which can result for example from corrosion of pipelines. Metal brushes are used in MFL tools as part of a magnetizing system that is used to magnetize the pipe that is being inspected. The ends of the metal brushes rub against the wall of the pipe and transmit the magnetic field to the measuring instrument/sensor. Sensors in the MFL tool then measure the magnetic field around a defect in a pipeline to provide a quantitative measure of the amount of damage to the pipeline.

As another example, metal brushes may be used as cleaning brushes, in pipeline cleaning applications. Cleaning pigs, which are known in the art, are used in a number of different applications, for example for regular maintenance of pipelines or to remove heavy deposit and buildup, as by scraping.

Metal brushes have previously been produced by bonding steel fibers to a ferrule or other support, by use of solder. However, the use of solder to bond the fibers to each other and to the ferrule or other support presents problems, and is not ideal. Solder may melt at temperatures that may be experienced during usage of the metal brush in an MFL tool. As it is not ferrous, it is somewhat insulating and therefore is less conductive than desired for some applications. The process of soldering uses flux, which causes corrosion. Further, solder is a malleable material and has inferior retention properties, causing the bristles tend to become detached from the solder, and therefore the brush.

### SUMMARY OF INVENTION

The present invention provides a new method of manufacturing a metal brush, a brush produced thereby and pipeline pigs comprising the brush. The ends of the bristles in the brush are fused together and into a bristle holder, by fusion welding. The use of fusion welding overcomes one or more of the problems associated with prior art metal brushes. The metal brush of the present invention when compared to a soldered brush, may be less likely to melt during usage in an MFL tool, may be more resistant to corrosion, may be more electrically conductive, may be better at transmitting a magnetic field, and the bristles may be less likely to become detached from the brush.

Therefore, in one aspect this invention is a metal brush having a brush surface and a contact surface, comprising a metal bristle holder that defines a retention cavity, a plurality of metal bristles, each with a first end and a second end, and wherein the first ends of the bristles within the retention cavity and are welded to each other and welded to the bristle holder by fusion welding.

The bristle holder may be a tube, or a structure comprising at least one said retention cavity. The plurality of bristles may be inserted into the retention cavity in a closely spaced relation to one another. The brush may have a contact surface that is flat.

In another aspect, the invention is a pipeline pig comprising the brush of this invention. The pipeline pig may be a magnetic flux leakage tool or a cleaning tool.

In another aspect, the invention is a method for making a metal brush with a brush surface and a contact surface, which method comprises providing a plurality of metal bristles, each bristle comprising a first end and a second end, inserting the first ends of the bristles into a retention cavity of a metal bristle holder, fusion welding the first ends of the bristles to each other and to the bristle holder, and optionally, removing excess filler metal deposited during the fusion welding process.

In one embodiment, the bristles may be welded together and to the bristle holder, at the same time. In another embodiment, the bristles may be welded together before they are inserted into the retention cavity. In one embodiment, the method may additionally comprise the step of flattening the contact surface. The first ends of the bristles may be inserted part way into the cavity or completely through the cavity.

In one embodiment, the bristles are inserted into the cavity in a closely spaced relation to one another. The bristle holder is either a tube, or a structure comprising at least one said retention cavity.

In yet another aspect, the invention is a pipeline pig comprising a brush made by the method of this invention. The pipeline pig may be a magnetic flux leakage tool or a cleaning tool.

In another aspect, the invention is a metal brush having a brush surface and a contact surface, and comprising a tubular metal bristle holder, a plurality of metal bristles each with a first end and a second end, wherein the first ends of the metal bristles are packed in a closely spaced relation and welded to each other and to the bristle holder, by fusion welding, and optionally a flat contact surface. In another aspect, the invention is a pipeline pig comprising this metal brush, such as a magnetic flux leakage tool and a cleaning tool.

In another aspect, the invention is a metal plate comprising at least one bundle of bristles, each bundle of bristles having a brush surface and a contact surface, and being packed in a closely spaced relation and being welded to each other and to the metal plate, by fusion welding, and optionally, having a flat contact surface. In another aspect, the invention is a pipeline pig comprising this metal plate, such as a magnetic flux leakage tool and a cleaning tool.

In another aspect, the invention is a method for making a metal brush with a brush surface and a contact surface, which method involves providing a plurality of metal bristles, each bristle comprising a first end and a second end, inserting the first ends of the metal bristles into a cavity of a metal bristle holder in a closely spaced relation, and such that a space remains in the cavity the bristle holder, fusion welding the first ends of the bristles to each other, and to the bristle holder, using additional filler metal to fill the space, and optionally, generating a flat contact surface. In another aspect, the invention is a pipeline pig comprising a metal brush made by this method, such as a magnetic flux leakage tool and a cleaning tool.

### BRIEF DESCRIPTION OF DRAWINGS

FIGS. 1A, 1B and 1C are partial cross sectional views of embodiments of a metal brush, showing a bundle of bristles welded to each other and to a bristle holder. In FIG. 1A the bristle holder is a tube, which is shown in longitudinal section. FIGS. 1B and 1C show bristle holders with differently shaped holes drilled therethrough and different profiles.

FIGS. 2A, 2B and 2C are partial cross sectional views showing a bundle of bristles arranged in the bristle holder and before the bristles are welded together and to the bristle holder. In FIG. 2A the bristle holder is a tube, which is shown in longitudinal section. In FIG. 2B the bristle holder is a hole. In FIG. 2C the bristles are extended beyond the end of the bristle holder.

FIGS. 3A, 3B and 3C are partial cross sectional views showing a method for making a metal brush. The bristle holder is a tube, which is shown in longitudinal section. FIG. 3B shows a bundle of bristles after the bristles have been welded together and to the bristle holder, but before the filler metal is ground to a desired shape. FIG. 3C shows the metal brush with the filler metal ground to the desired shape and the other end of the brush profiled.

FIGS. 4A, 4B and 4C are cross sectional views along line I-I of FIG. 2A (A and B), or line II-II of FIG. 2B showing a bundle of bristles assembled in the bristle holder, before the bundle is welded to the bristle holder.

FIG. 5A is a side view of a plurality of brushes secured to a metal plate and 5B is a perspective view of a plurality of bundles of bristles welded to a metal plate.

### DETAILED DESCRIPTION

Brush

Reference will now be made to the Figures, which show various embodiments of the metal brush. The metal brush 10 comprises at least one bundle 12 of bristles 14, the ends of which are welded to each other and also to a bristle holder 16 with filler metal 28.

“Metal”, as used herein, includes alloys.

“Welding” is a reference to fusion welding, which is a coalescence of metals that is achieved through the application of sufficient heat with or without pressure to melt the base metal. Fusion welding is distinct from non-fusion welding processes such as soldering. In non-fusion welding, a filler metal that has a melting point well below the melting point of the base metal is used to bond two different metal parts together, and the base metal does not actually melt.

Non-limiting examples of fusion welding processes included herein are arc-welding (shielded-metal arc welding, gas-tungsten arc welding, plasma arc welding, gasmetal arc welding, flux-cored arc welding and submerged arc welding), resistance welding, electroslag welding, electron-beam welding and laser beam welding.

“Filler metal” is a reference to molten metal formed during the welding process. In fusion welding processes, the base metal melts and fuses with other metals that may be added by the welding process. Filler metal may comprise base metal alone, for example metal from the bristles and the bristle holder, or it may comprise base metal and additional metal added by the welding process.

Bristle holder 16 may be a metal construct that comprises at least one retention cavity 20, such as an opening or hole, which is capable of accepting bundle 12 of bristles. Retention cavity 20 may be accessible from both ends, or it may be closed or partially closed at one end, provided that the bristle ends may still be welded to each other and to the bristle holder.

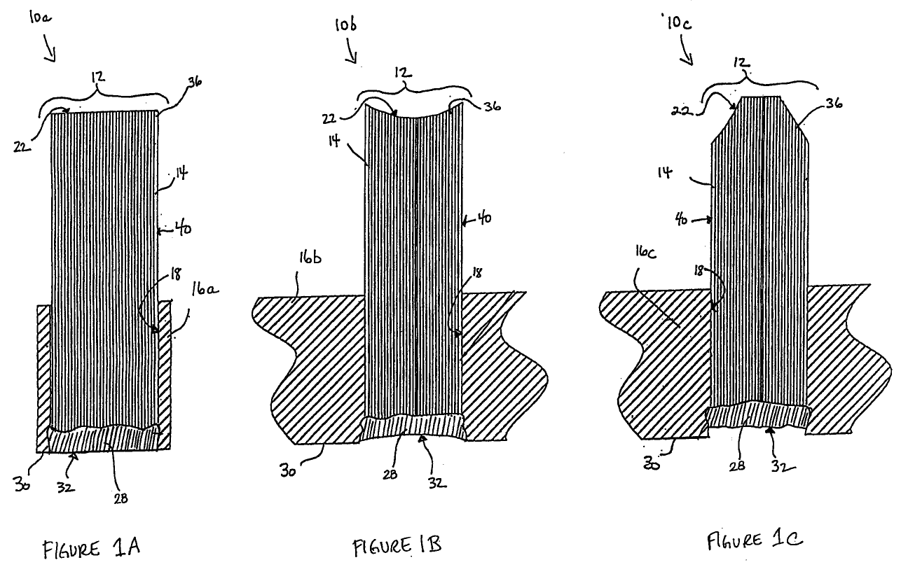

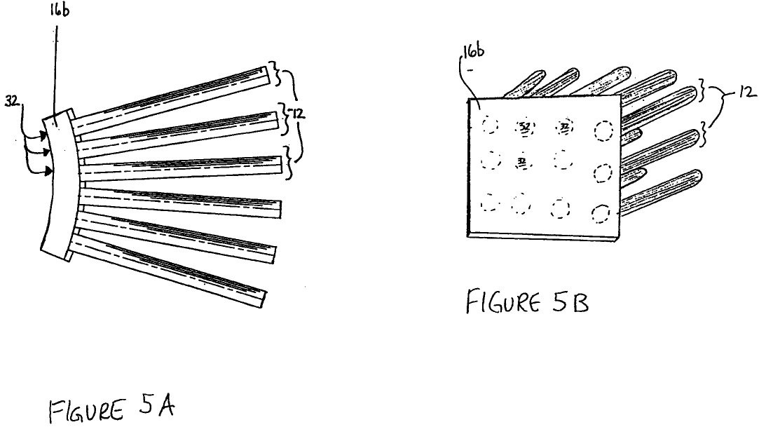

In one embodiment, bristle holder 16 may be a metal tube or ferrule, as shown in FIGS. 1A, 2A, 2C, 3A-C, 4A and 4B. The metal tube forms a retention cavity 20 that includes a metal inner surface 18, to which bristles 14 may be fused by the welding process. Some embodiments of these types of brushes are known in the art as pencil brushes. This embodiment of brush 10 may be used, for example, by securing one or more brushes 10 to a larger device, for example a pipeline pig that may be used as an MFL tool or as a cleaning tool. As non-limiting examples, a pipeline pig may comprise a series of holes bored around its perimeter, in a series of circles, or a helical arrangement, or an irregular/random arrangement, and within at least some holes may be secured a brush 10. An example of this is shown in FIG. 5A. The brush 10 may be secured, for example by glue, by welding, or by transition fit. After one or more brushes are secured into the holes of the larger device a mounting plate may be screwed onto the device, in contact with mounting surface 32 of the brush 10.

In another embodiment, bristle holder 16 may be a larger structure comprising at least one retention cavity 20, as shown in FIGS. 1B, 1C, 2B, and 4C. In this embodiment, bristle holder 16 may be a metal plate, a metal tube, a tool (i.e., a pipeline pig), a part of a tool or machine, or other such entity, into or through which one or more retention cavities 20 may be bored. The plate, sheeting, tube, tool, machine, or other such part may form one or more retention cavities 20, of the same or different shapes, each of which may be capable of accepting a bundle 12 of bristles. Accordingly, in this embodiment bristle holder 16 may hold more than one bundle of bristles, examples of which are shown in FIG. 5B. As non-limiting examples, bristle holder 16 may be a rectangular metal plate that comprises a series of retention cavities 20 bored in linear arrays, a helical arrangement, or an irregular/random arrangement, and into which at least one of may be welded a bundle 12 of bristles 14. After one or more bundles of bristles are welded to the retention cavities 20 of the larger device, a mounting plate may be screwed onto the device, in contact with the flat mounting surface 32 of the brush 10.

As is apparent, bristle holder 16, regardless of whether it is a metal tube or a larger structure, may have a retention cavity that is any of a number of shapes in cross section, including but not limited to, circular, oval, polygonal (for example, triangular, tetragonal, hexagonal), crenate, scalloped, and irregular.

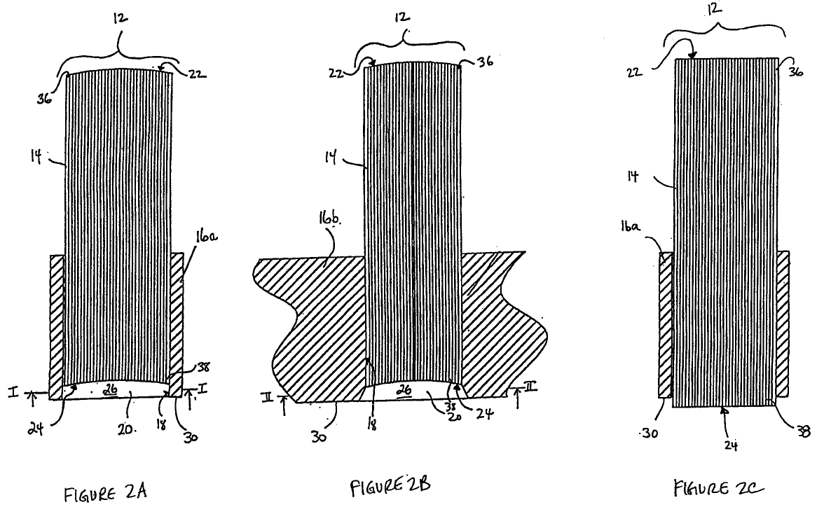

The retention cavity 20 may have sides that are parallel to one another, as in a cylinder. Retention cavities such as these are as shown in FIGS. 2A and 2C. Alternatively, retention cavity 20 may have sides or a portion thereof that are not parallel to one another, but rather are curved, flared, cone-shaped or irregular in shape. A retention cavity 20 may be frustoconically formed (i.e., flanged) at one end is shown in FIG. 2B, which cavity may permit better retention of the wires, as additional filler metal may be used.

Bristle holder 16 may be made of metal, which in one embodiment may be steel. If used in an MFL tool magnetic transmissivity may be important, and the steel may be carbon steel, for example. If used in a cleaning pig, transmissivity and conductivity may be less important, and the steel may be stainless steel, for example. Any of a number of different types of metals may be used, depending upon the application. For example, if electrical conductivity is important, copper may be used.

The bristles 14 of bundle 12 may be packed in a closely spaced relation within bristle holder 16, meaning that the bristles may be packed so as to minimize the amount of air space between the bristles and to maximize the amount of contact of the bristles. Packing of the bristles 14 in a closely spaced relation within bristle holder 16, prior to welding of the bristles to one another and to the bristle holder, may be important for brushes used in MFL tools, as decreasing the air space increases the transmissivity. Close packing may also be important for maximizing the durability and lifespan of brush 10. If the bristles are packed in a closely spaced relation, they will fuse more substantially and more completely to each other and to the bristle holder, and may therefore be less likely to become detached from the bristle holder during use of the brush. However, for a cleaning brush, packing in a closely spaced relation may be less important.

The bundle 12 of bristles has a brush surface 22 and a bound surface 24. At brush surface 22 of the bundle, the individual bristles 14 may not be attached to one another. At bound surface 24 the bristles are welded to one another, and the outer bristles are fused, by welding, to bristle holder 16.

Bound surface 24 of the bundle 10 of bristles 14 may extend part way through and up to completely through, retention cavity 20. In one embodiment, shown in FIGS. 1-4, bound surface 24 of bundle 10 extends part way through retention cavity 20, thus leaving a space 26 at one end of the retention cavity. Depending upon the pull strength desired, the space 26 may be increased or decreased. Generally, the greater space 26, the greater will be the pull strength, and the smaller the space, the lesser will be the pull strength, when the space is filled with filler metal. In another embodiment, shown in FIG. 2C bristles 14 may extend all the way through retention cavity 20 past end 30 of bristle holder 16. In yet another embodiment, bristles 14 may extend all the way through retention cavity 20 to end 30 of bristle holder 16. In these embodiments, no space 26 may be left at the end of retention cavity 20.

In the completed brush 10, space 26 may be filled with filler metal 28. For example, for a brush in an MFL tool, space 26 may be filled with filler metal, whereas for a brush in a cleaning tool, it may not be.

The brush surface 22 and bound surface 24 of the bundle of bristles may have a flat profile, as shown in FIG. 1A, 2C, 3A and 3B or a contoured profile as shown in FIGS. 1B, 1C, 2A, 2B and 3C. It is understood that the bristle bundle can have any one of a number of contoured profiles at either end, including, for example a peak, a valley (i.e., inverted V), grooves or an irregular/random profile. As is apparent, brush surface 22 and bound surface 24 may have different profiles.

Bristles 14 are metal filaments, fibers, tubes or other such elongate structure. Any of a number of different types of metals may be used, depending upon the application. For example, in one embodiment the metal may be steel, for example carbon steel. In another embodiment, the bristles may be coated wires. In brushes used for MFL tools, magnetically transmissive metals may be used. In brushes used for cleaning tools, transmissivity or conductivity of the bristle may not be important. A brush 10 may be made of more than one type of bristle 14.

The cross-sectional shape and size of bristles 14 useful in metal brush 10 may be selected to maximize the contact of the bristles with one another, and to minimize the air space between the bristles. A number of different cross-sectional shapes and sizes of bristles 14 may achieve this result. As non-limiting examples, the bristles may be circular, oval, polygonal (non-limiting examples are triangular, tetragonal, hexagonal) or irregular in cross section. The bristles may be packed tightly within the bristle holder, resulting in no, or negligible, air space between the bristles. The packing of bristles 14 having a circular shape or hexagonal shape in cross section is shown in FIGS. 5A and 5B. As is apparent, all bristles in a bundle of bristles need not have the same or similar cross-sectional shape or size, as shown in FIG. 5C, in order to achieve a closely spaced relation within the bristle holder.

In metal brush 10, bristles 14 are welded to each other and to bristle holder 16 by fusion welding. As is apparent, only the outermost bristles 14 in bundle 12 will be welded directly to bristle holder 16. Examples of processes that may be used to weld the bristles to one another and to the bristle holder are metal inert gas (MIG) welding, tungsten inert gas (TIG welding) or quasi-arc welding. The metal rod used may be a steel rod.

As stated above, the types of welding included herein may or may not use additional metal, in addition to the base metal provided from the bristles and the bristle holder. Therefore, in one embodiment of brush 10, space 26 may be filled with filler metal 28, which results from the welding process. In another embodiment of brush 10, space 26 may not be filled with filler metal.

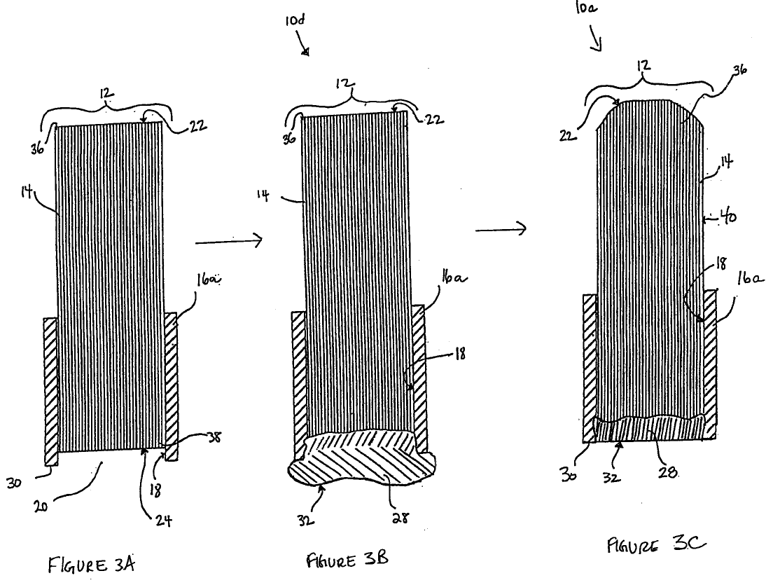

Contact surface 32 of metal brush 10 may have any of a number of different profiles. In the embodiment shown in FIGS. 1A and 3C, contact surface 32 has a flat profile which may be contiguous with end 30 of bristle holder 16. A brush with a flat profile at contact surface 32 is useful in an MFL tool, as a flat surface will maximize transmissivity. However, as is apparent, contact surface 32 alone, or in conjunction with end 30, may have one of a number of other profiles, such as for example, a convex, concave, peaked, grooved or even irregular profile, as shown in FIGS. 1B, 1C and 3B. Contact surface 32 may even extend beyond end 30, as shown in FIG. 3B, which may be used, for example, as a cleaning brush.

Method of Making a Brush

Metal brush 10 may be made by assembling the bundle 12 of bristles 14 within bristle holder 16, and then welding the ends of the bristles to each other and to the bristle holder. Alternately, metal brush 10 may be made by assembling the bundle 12 of bristles 14, welding the ends of the bristles together and then inserting the welded end of the bundle into the bristle holder 16 and welding it thereto.

Bristles 14, which have a first end 38 and a second end 36, are assembled in parallel arrangement and/or first end 38 is inserted into bristle holder 16. Bristles 14 may be inserted into bristle holder singly, or as an assembled bundle.

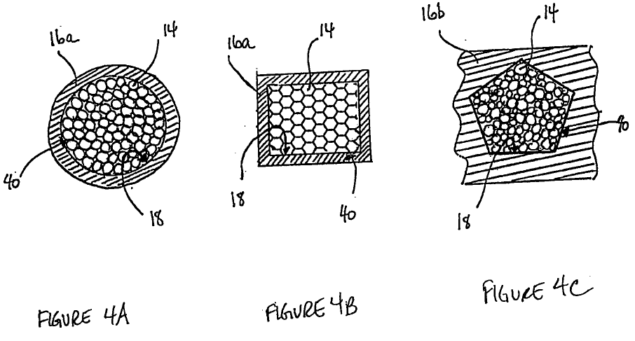

As shown in FIG. 4A-C, bristles 14 may be tightly packed into the bristle holder, to provide for a bundle of bristles with negligible or no air space between the bristles. As is apparent, there may be some airspace between the outer surface 40 of the bundle of bristles and the inner surface 18 of bristle holder 16. Vibration or other means may be used to achieve tight packing, if that is an object of the packing. One means of inserting the bristles into the bristle holder is by using an inverted-cone shaped device, as is known by those of skill in the art. Spacers may be used between bristles, in some embodiments.

While bristles 14 are being assembled together and before first ends 38 are welded together, the profile of brush surface 22 or bound surface 24 of the bundle may be selected. For example, either end of the bundle may be substantially flat in profile, as shown in FIG. 3A, or it may be contoured, as shown in FIGS. 2A and 2B. Various molds, as known to those skilled in the art, may be used to form the bound and/or brush surface of the bundle of bristles into a particular contoured profile. For example, a mold that comprises a series of concave spaced depressions may be used to provide a convex profile on a plurality of bundles of bristles that are assembled in a metal plate.

Alternately, the profile of brush surface 22 or bound surface 24 may be selected after the first ends 38 of bristles 14 have been welded together, an example of which is shown in FIG. 3C. In this embodiment of the method, brush surface 22 and/or bound surface 24 may be shaped, as by grinding, to provide a desired profile.

The bundle 12 of bristles may be inserted into bristle holder 16 a distance that is sufficient to securely retain each bristle therein after welding has been completed. In one embodiment of the method, the bundle 12 of bristles may be inserted so that space 26 remains at one end of the cavity 20 of bristle holder 16, which space may ultimately be filled in with filler metal 28, or which space or part thereof, may remain after the welding process has been completed.

Alternatively, the bundle 12 of bristles 14 may be inserted until the end of the bundle is substantially even with end 30 of bristle holder 16, or until the end of the bundle extends beyond end 30 of the bristle holder 16, as shown in FIG. 2C.

After bristles 14 are arranged and positioned in bristle holder 16, first ends 38 of bristles 14 may be welded to one another and to the bristle holder. Alternatively, if a welded bundle is inserted into bristle holder 16, the end of the bundle may be welded to the bristle holder. One example of how bristles 14 may be welded to one another and to the bristle holder is by MIG welding, as disclosed above. This process will cause the first ends 38 and metal surface 18 to melt, into a molten base metal, which may blend with any additional metal that may added during the welding process, to produce filler metal 28, as shown in FIGS. 3B and C. As disclosed above, welding may be accomplished without the use of additional metal, so that filler metal 28 comprises only base metal. The filler metal 28 functions not only to hold the bristles 14 in the brush, but also to fill in air spaces between bristles 14 and the bristles and bristle holder, to improve the transmissibility of embodiments of brush 10 that are used, for example, in an MFL tool. As is apparent, for embodiments of brush 10 that are used in cleaning applications, transmissibility and conductivity may not be an important a feature of the brush.

If there is a space 26, then filler metal 28 may fill the space, as shown in FIG. 3B or 3C. Alternatively, space 26 may not be filled in, as shown in FIG. 1C. Alternatively yet, if the bristles are inserted to, or beyond end 30 of bristle holder 16, there may be no space at all, as shown in FIG. 2C.

After the welding process is complete, contact surface 32 of the metal brush 10 may be ground to a desired profile. This profile may be selected from any of a number of profiles, as disclosed above. For brushes 10 used in MFL tools, the profile of contact surface 32 may be flat. For brushes used in cleaning tools, the profile of contact surface 32 is of less importance, and it may not be ground at all, but rather may be left as shown in FIG. 3B or 1C.

While the metal brush has been described in conjunction with the disclosed embodiments, it will be understood that the metal brush is not intended to be limited to these embodiments. On the contrary, the metal brush is intended to cover alternatives, modifications and equivalents, which may be included within the spirit and scope of the metal brush as defined by the appended claims.

1. A metal brush having a brush surface and a contact surface, comprising:
(a) a metal bristle holder that defines a retention cavity;
(b) a plurality of metal bristles, each with a first end and a second end, said first ends being within said cavity and being welded to each other and welded to the bristle holder by fusion welding.

2. The brush of claim 1, wherein the bristle holder is either (a) a tube, or (b) a structure comprising at least one said retention cavity.

3. The brush of claim 1, wherein the bristle holder is a tube.

4. The brush of claim 1, wherein the plurality of bristles are inserted into the retention cavity in a closely spaced relation to one another.

5. The brush of claim 1 wherein the contact surface is flat.

6. A pipeline pig comprising the brush of claim 1.

7. The pipeline pig of claim 6 selected from the group consisting of: a magnetic flux leakage tool and a cleaning tool.

8. A method for making a metal brush with a brush surface and a contact surface, comprising:
(a) providing a plurality of metal bristles, each bristle comprising a first end and a second end,
(b) inserting the first ends of the bristles into a retention cavity of a metal bristle holder,
(c) fusion welding the first ends of the bristles to each other,
(d) fusion welding the first ends of the bristles to the bristle holder, and optionally,
(e) removing excess filler metal deposited during the fusion welding process.

9. The method of claim 8 wherein step (c) and step (d) are performed simultaneously.

10. The method of claim 8 wherein step (b) is performed after step (c).

11. The method of claim 8, further comprising the step of flattening the contact surface.

12. The method of claim 8, wherein the first ends of the bristles are inserted into the cavity a distance that is either: (a) part way through the cavity or (b) completely through the cavity.

13. The method of claim 8, wherein the first ends of the bristles are inserted into the cavity in a closely spaced relation to one another.

14. The method of claim 8, wherein the bristle holder is either: (a) a tube, or (b) a structure comprising at least one said retention cavity.

15. The method of claim 8, wherein the bristle holder is a tube.

16. A pipeline pig comprising a brush made by the method of claim 8.

17. The pipeline pig of claim 16 selected from the group consisting of: a magnetic flux leakage tool and a cleaning tool.

18. A metal brush having a brush surface and a contact surface, and comprising:
(a) a tubular metal bristle holder and a plurality of metal bristles each with a first end and a second end,
(b) wherein the first ends of the metal bristles are packed in a closely spaced relation and welded to each other and to the bristle holder, by fusion welding, and optionally,
(c) a flat contact surface.

19. A pipeline pig comprising the brush of claim 18.

20. The pipeline pig of claim 19 selected from the group consisting of: a magnetic flux leakage tool and a cleaning tool.

21. A metal plate comprising:
(a) at least one bundle of bristles, each bundle of bristles having a brush surface and a contact surface, and being:
(i) packed in a closely spaced relation and
(ii) welded to each other and to the metal plate, by fusion welding, and optionally,
(iii) having a flat contact surface.

22. A pipeline pig comprising the metal plate of claim 21.

23. The pipeline pig of claim 22 selected from the group consisting of: a magnetic flux leakage tool and a cleaning tool.

24. A method for making a metal brush with a brush surface and a contact surface, comprising:
(a) providing a plurality of metal bristles, each bristle comprising a first end and a second end,
(b) inserting the first ends of the metal bristles into a cavity of a metal bristle holder in a closely spaced relation, and such that a space remains in the cavity the bristle holder,
(c) fusion welding the first ends of the bristles to each other, and to the bristle holder, using additional filler metal to fill the space, and optionally,
(d) generating a flat contact surface.

25. A pipeline pig comprising a brush made by the method of claim 24.

26. The pipeline pig of claim 25 selected from the group consisting of: a magnetic flux leakage tool and a cleaning tool.
